(19) United States
(12) Patent Application Publication
(10) Pub. No.: US 2025/0034666 A1
(43) Pub. Date: Jan. 30, 2025

(54) IRON RECOVERY

(71) Applicant: MANIC IRON TECHNOLOGY PROPRIETARY LIMITED, Lanseria, Johannesburg (ZA)

(72) Inventors: John Peter Beachy Head, Lanseria, Johannesburg (ZA); Jorge Octavio Becerra Novoa, Monterrey (MX)

(21) Appl. No.: 18/714,844

(22) PCT Filed: Dec. 2, 2022
(86) PCT No.: PCT/ZA2022/050065

§ 371 Date: May 30, 2024

(30) Foreign Application Priority Data
Dec. 2, 2021 (ZA) 2021/09859

(51) Int. Cl. C21B 13/00; F27B 15/08; F27B 15/14; F27D 3/00

(52) U.S. Cl. CPC C21B 13/0033; C21B 13/0066; F27B 15/08; F27B 15/14; F27D 2003/0038

(57) ABSTRACT

The invention provides a method of reducing ferrous metal fines derived from waste or from ferrous ore, including feeding a fine ferrous material with a particle size distribution of between 10 microns to less than 6 mm and a reductant into an indirectly heated vibratory bed furnace, and contacting the fine ferrous material with the reductant in the indirectly heated vibratory bed furnace at a temperature of up to 1350° C. to produce a hot direct reduced ferrous metal.

### BACKGROUND OF THE INVENTION

This invention relates to a method for the recovery of ferrous metals from ferrous ores and, in particular, from ferrous ore fines including ferrous waste materials such as tailings from the mining industry.

In the mining industry, a significant amount of ferrous ore fines is generated. These fines/slimes are often discarded as waste into tailings ponds, containing considerable amounts of ferrous ores. In recent years, interest in recovery of valuable minerals from low-grade ores, slimes, and tailings has increased worldwide. These activities are initiated not only to recover minerals but also to address various environmental issues associated with fine particle treatment.

Various methods have been proposed for the direct recovery of ferrous metals from ferrous ore fines. One such method, of the kind described in U.S. Pat. No. 8,613,787B2, discloses the use of a rotary kiln in which devolatized coal and iron ore, in the form of pellets or fines, are fed into the rotary kiln and the kiln is then indirectly heated to a temperature in the range of 1000° C. to 1100° C. The reaction which takes place in the kiln proceeds as follows:

Fe_{y}O_{y}+C→xFe+yCO (1)

FeₓO_{y}+CO→xFe+yCO₂ (2)

CO₂+C→2CO (3)

The CO produced in reaction (3) will continue reacting as indicated in reaction (2).

While the direct reduction of iron ore and iron ore fines is possible using a rotary kiln, this process does have limitations. As the kiln is heated indirectly, there is a constraint in the reduction temperature due to construction materials of the kiln and the size required for an industrial production. Very high temperatures cannot be reached and typically the temperature will be less than 1050° C.

Furthermore, during the devolitilization of coal, the required energy is supplied by direct heating of the coal by partial combustion of the volatile gas. This results in several disadvantages. Firstly, a variable quality of gases is produced which makes its further utilization very complicated. Secondly, there is no way to control the flame inside the devolatilization kiln which results in localized areas of high temperature that damage the equipment as a result of flame impingement.

Once the iron ore has been reduced, the resulting direct reduced iron, ashes and char are cooled. However, the mix of these heterogeneous materials makes indirect cooling a difficult task.

A need therefore exists to provide an alternative method of reducing ferrous ore fines, in an energy efficient manner, which allows higher temperatures to be reached and better control of the process.

The invention aims, at least partially, to achieve these objectives.

### SUMMARY OF INVENTION

The invention provides a method of reducing ferrous metal fines derived from waste or from ferrous ore, the method including the steps of:
a) feeding a fine ferrous material with a particle size distribution of between 10 microns to less than 6 mm and a reductant into an indirectly heated vibratory bed furnace; and
b) contacting the fine ferrous material with the reductant in the indirectly heated vibratory bed furnace at a temperature of up to 1350° C. to produce a hot direct reduced ferrous metal.

Preferably the fine ferrous material has a size of less than 500 microns. The ferrous ore may be chromite, iron oxide or manganese fines.

Preferably the temperature in step (b) is in the range of 1000° C. to 1350° C., more preferably, 1200° C. to 1350° C.

The method may include a first preliminary step of preheating the fine ferrous material to a temperature of between 400° C. to 500° C. to remove excess moisture and to reduce the energy demand in the reduction bed.

The reductant may be a carbon-containing material such as coal. The carbon-containing material may have a particle size distribution of less than 1 mm.

If the reductant is coal, the method may include a second preliminary step of devolatilization of the coal through indirect heating with combustion gases to produce char. The char may then be fed into a reduction bed of the furnace. This is done without cooling the char in order to reduce the energy demand of the reduction bed.

The volatile combustible gases produced due to the devolatilization of coal in the second preliminary step and in step (b) may proceed to a gasometer. The combustible gases may be cooled and cleaned prior to passing into the gasometer. The purpose of the gasometer is to provide several steps in the process which use the combustible gases with a more stable gas composition and with a stable flow according to the demand. The gases from the gasometer may be used in the second preliminary step, step (b) and in a subsequent recovery step.

The method may also include the step of recovering sensible heat from combustible gases emitted as a result of devolatilization of the coal to be used to preheat the combustion gases used in the second preliminary step. Sensible heat may also be recovered from combustible gases produced in step (b) to be used to preheat combustion gases for use in the furnace.

The method may include an additional recovery step (c) wherein the hot direct reduced ferrous metal is indirectly heated in a melting unit together with combustion gases produced by burning fuel from the gasometer with preheated air to a temperature of about 2000° C. to produce a liquid ferrous metal and a liquid slag.

The liquid ferrous metal may be sent to a granulator to produce a granulated ferrous metal.

The liquid slag may be used as an aggregate substitute or as an extender in a cement manufacturing process. Alternatively, the liquid slag may be sent to waste.

If coal is used as a reductant in step (b), the char and fine ferrous material may be fed into the vibratory bed furnace at a controlled ratio which depends on the quality of material used and the excess of reductant needed to meet the desired carbon content in the liquid ferrous metal.

The residence time of the char and the ferrous fines in the reduction bed of the furnace may be controlled to achieve the desired degree of reduction. The residence time is dependent on the fines characteristics and on the operating temperature. Preferably the residence time is below 15 minutes.

The use of the vibratory bed furnace allows vibrations and combustible gas evolution to create interstitial space to promote solid/solid and solid/gas reduction reactions within the furnace. The vibration action lifts the burden within the furnace to create interstitial space to allow gas movement and to promote the reduction reactions within the furnace.

The vibratory bed furnace may of the kind described below.

The invention further extends to a furnace which comprises a structure in which is formed a production chamber, at least one inlet port for feeding product to be processed into the production chamber, at least one discharge port through which processed product is discharged from the production chamber, a heating arrangement configured to heat product which is in the production chamber to a predetermined temperature and a mechanism which is configured and which is operative to impart controlled vibratory movement to the production chamber and to the product in the production chamber.

The product which is to be processed is typically in fine particulate form. A primary function of the vibratory mechanism is to impart vibratory movement to the production chamber and hence to the particulate material in the production chamber so that, in effect; a suspension of the particulate material in the prevailing atmosphere is achieved. In this way, each particle is effectively removed or displaced from surrounding particles and its surface is fully exposed and hence the particle can then present a maximum surface area to enable reduction to take place.

In one form of the invention the product to be processed is ferrous oxide with a particle size of less than 500 microns.

The heating arrangement should be configured to heat the product in the production chamber to an operating temperature of up to 1350° C.

Through the vibratory movement the particles of the production chamber are thereby interstitially spaced from one another.

The heating arrangement is preferably at a location which is below the production chamber. The inlet port may be at or near a first end of the production chamber. The discharge port may be at or near a second end of the production chamber which is remote from the first end.

The structure may include an outlet from the production chamber through which combustible gas, produced upon heating and hence the reduction of the product in the production chamber, is directed.

The combustible gases may be directed to a gasometer and from there to a combustion system and hot combusted gas from the combustion system may be employed in the heating arrangement.

The vibratory mechanism may be of any suitable nature. In one embodiment the structure is mounted to a frame with a vibratory mechanism between the frame and the structure. The vibratory mechanism may include rubber or similar vibratory suspension elements between the frame and the structure.

Through the use of a suitable actuator using techniques which are known in the art, vibratory movement is imparted to the structure which causes the structure to move up and down in a generally vertical direction relative to the frame.

In one respect the particles in the production chamber are aerated by forcing interstitial spacing and the particles are thereby effectively placed in what may be regarded as a suspension.

In one form of construction, the production chamber is located in an upper housing and the heating arrangement is located in a lower housing positioned below the upper housing with a refractory medium between the housings.

### DESCRIPTION OF THE DRAWINGS

The invention is further described by way of example with reference to the accompanying drawings in which:

FIG. 1 is a view in perspective from above of a furnace according to one form of the invention;

FIG. 2 is a side view of the furnace shown in FIG. 1;

FIG. 3 illustrates a method of recovering ferrous metals from ferrous ore according to the invention; and

FIG. 4 illustrates a ferrous metal recovery step according to the method of the invention.

### DESCRIPTION OF PREFERRED EMBODIMENTS

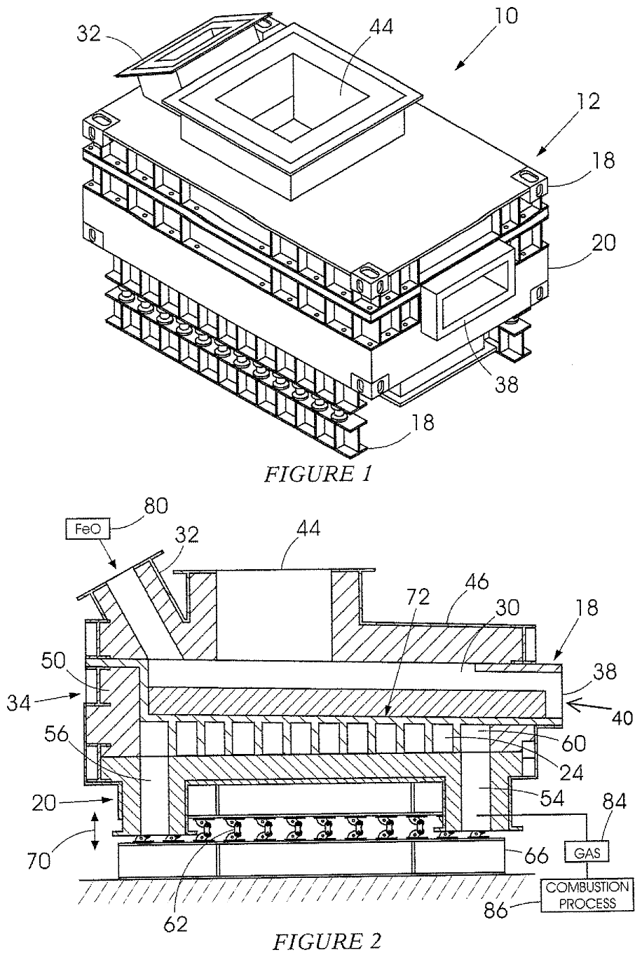

FIG. 1 of the accompanying drawing illustrates a furnace 10 according to the invention. FIG. 2 shows the furnace 10 from one side and in cross-section.

The furnace 10 comprises a structure 12 which is mounted to a base frame 14.

The structure 12 comprises an upper housing 18 and a lower housing 20. The two housings are separated by a hot face refractory medium 24.

The upper housing 18 encloses a production chamber 30. A downwardly inclined inlet port 32 is formed close to a first end 34 of the production chamber 30. A discharge port 38 is formed close to a second end 40 of the production chamber 30. The second end 40 is remote from the first end 34. An outlet 44 is formed in an upper wall 46 of the upper housing. Insulating refractory material 50 surrounds the production chamber 30 as may be appropriate.

The hot face refractory medium 24 extends downwardly from the upper housing 18 into the lower housing 20. The lower housing embodies a heating arrangement for product in the upper housing. Heating is achieved by means of a hot combusted gas which is introduced through an inlet 54 and which exits the lower housing through a gas discharge port 56 which is displaced from the inlet 54.

The structure 12 is mounted to an upper support frame 60 upon which the structure rests. Vibratory suspension elements 62 made from rubber or equivalent material are positioned between the upper support frame 60 and a lower support frame 66 which rests on the ground. Through the use of an actuator (not shown) using techniques which are known in the art, up-down vibratory movement, in a generally vertical sense, can be imparted to the structure so that it is moved in an up-down generally vertical sense relative to the lower support frame 66 as is indicated by double-headed arrows 70.

An examination of FIG. 2 shows that a base 72 of the production chamber 30 is inclined downwardly moving away from the inlet port 32 to the discharge port 38.

In use of the furnace, ferrous oxide fines 80 with a particle size of less than 500 microns are fed at a controlled rate from a source through the inlet port 32 into the production chamber 30. Hot combusted gas 84 produced by a gas combustion process 86 is fed at a controlled rate into the heating arrangement embodied in the lower housing 20 through the inlet port 54. An objective in this respective is to use the hot combusted gas 84 to heat the product in the production chamber 30 to a temperature of up to 1350° C. Gas which leaves the lower housing is discharged through the port 56.

Ferrous ore particles and char comprise the product feed. The indirect heating process carried out in the lower housing 20 by the hot combusted gas 84 causes the ferrous ore and the char to react and the ferrous is directly reduced to produce high metallization metal fines.

In the reduction process the ferrous oxides are reduced via CO producing CO₂. The CO₂ reacts with the carbon in the char as to produce 2CO and the CO is again used for reduction.

Gases which are produced as a result of the reduction process are very rich in CO which is combustible and are exhausted through the outlet 44 and then directed to the combustion process 86 through the gasometer and fuel gas handling system.

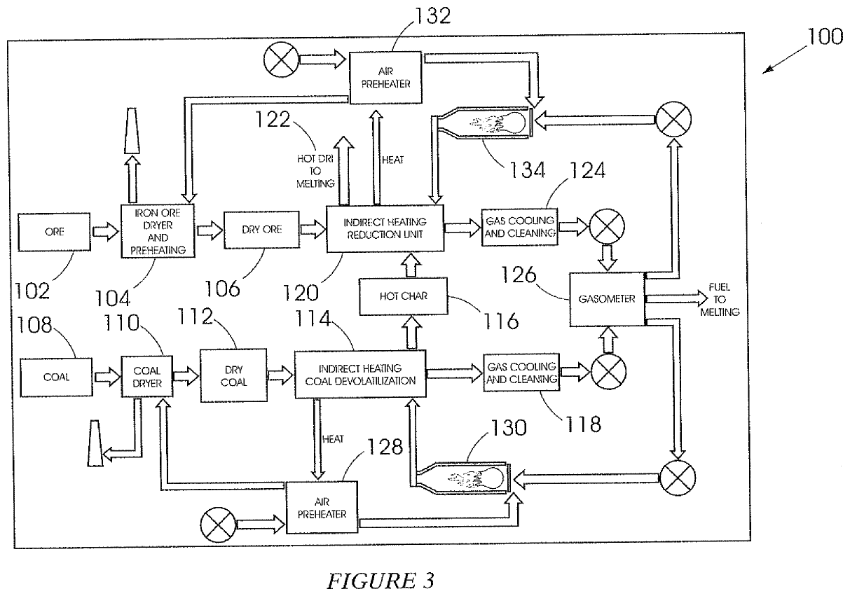

FIG. 3 illustrates a method 100 of recovering ferrous metals, from ferrous fines according to the invention.

In a first preliminary step, ferrous fines 102 are heated (104) to a temperature of 400° C. to 500° C. in order to remove excess moisture to provide a dry ore product 106. The ferrous fines have a size in the range of 10 microns to 6 mm. Preferably, the ferrous fines have a size of less than 500 microns.

Coal 108 is also heated (110) in order to remove excess moisture to provide a dry coal product 112. If the coal is coarse, the coal is ground to a size of less than 1 mm prior to heating.

In a second preliminary step, the dry coal 112 is subject to a devolatilization step 114 wherein the coal 112 is heated indirectly to remove volatile matter to provide a hot char product 116 and volatile gas 118.

The hot dry fines product 106 and the hot char product 116 are fed into a reduction unit in the form of a vibratory bed furnace 120 in a ratio to be controlled according to the specific properties and quality of the fines and the char as well as to the desired carbon content in the final granulated ferrous product. Preferably, the vibratory bed furnace is of the kind described herein. The furnace 120 is indirectly heated to a temperature of up to 1350° C. for a process retention time of preferably less than 15 minutes to produce a hot direct reduced ferrous product 122 and combustible gas 124.

The gasses 118 and 124 are cooled and cleaned and are send to a gasometer 126. The gas from the gasometer 126 is combusted with preheated air 128 in a combustion chamber 130 to provide hot combusted gases which are used to indirectly heat the coal 112 in the devolatilization step 114.

The gasses from the gasometer are also combusted with preheated air 132 in a combustion chamber 134 to provide hot combustion gases which are used to indirectly heat the burden in the vibratory bed furnace 120.

The remaining sensible heat from the combustion gas used in the furnace 120 is used in the heat exchanger 132 to preheat the combustion air for use in the combustion chamber 134. The remaining sensible heat in the combustion gas used in the devolatilization unit 114 is used to preheat the combustion air to be used in the combustion chamber 130 in the heat exchanger 128.

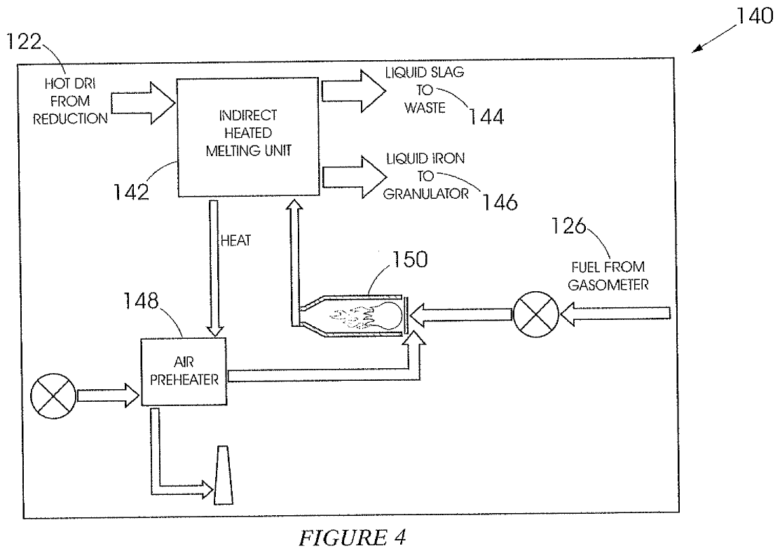

FIG. 4 illustrates a ferrous recovery step 140 according to the invention. The hot direct reduced ferrous 122 product is indirectly heated in a melting unit 142 together with gases stored in the gasometer 126 and combusted in the combustion chamber 150 to a temperature of about 2000° C. By indirect contact with the combustion gases, a liquid ferrous product 146 and a liquid slag 144 are produced. The remaining sensible heat from the combustion gases used in the melting unit 142 is used to preheat the combustion air used in the combustion chamber 150 through a heat exchanger 148.

The liquid ferrous metal is sent to a granulator to produce a granulated ferrous product. The liquid slag is used as an aggregate substitute or an extender in a cement manufacturing process, or is sent to waste.

1-23. (canceled)

24. A method of reducing ferrous metal fines derived from waste or from ferrous ore, the method including the steps of:
a) feeding a fine ferrous material with a particle size distribution of between 10 microns to less than 6 mm and a reductant into an indirectly heated vibratory bed furnace;
b) contacting the fine ferrous material with the reductant in the indirectly heated vibratory bed furnace at a temperature of up to 1350° C. to produce a hot direct reduced ferrous metal; and wherein the vibratory bed furnace creates a vibratory action which lifts the burden within the furnace to create interstitial spaces to allow gas movement and to promote the reduction reactions within the furnace.

25. A method according to claim 24, wherein the fine ferrous material has a size of less than 500 microns.

26. A method according to claim 24, wherein the ferrous ore is selected from at least one of chromite, iron oxide, and manganese fines.

27. A method according to claim 24, wherein the temperature in step (b) is in the range of 1000° C. to 1350° C.

28. A method according to claim 24, further comprising, prior to feeding the fine ferrous material, preheating the fine ferrous material to a temperature of between 400° C. to 500° C.

29. A method according to claim 24, wherein the reductant is a carbon-containing material having a particle size distribution of less than 1 mm.

30. A method according to claim 29, wherein the carbon-containing material is coal.

31. A method according to claim 30, further comprising, prior to feeding the fine ferrous material, a preliminary step of devolatilization of the coal through indirect heating with combustion gases to produce char.

32. A method according to claim 31, wherein volatile combustible gases produced in the preliminary step and in step (b) proceed to a gasometer.

33. A method according to claim 32, wherein the gases from the gasometer are used in the preliminary step, step (b), and in a subsequent recovery step.

34. A method according to claim 33, further comprising recovering sensible heat from combustible gases emitted as a result of devolatilization of the coal to be used to preheat the combustion gases used in the preliminary step.

35. A method according to claim 31, further comprising an additional recovery step (c) wherein the hot direct reduced ferrous metal is indirectly heated in a melting unit together with combustion gases produced by burning fuel from the gasometer with preheated air to a temperature of about 2000° C. to produce a liquid ferrous metal and a liquid slag.

36. A method according to claim 31, wherein a residence time of the char and the ferrous fines in the vibratory bed furnace is less than 15 minutes.

37. A furnace for use in the method of claim 24, the furnace comprising a structure in which is formed a production chamber, at least one inlet port for feeding product to be processed into the production chamber, at least one discharge port through which processed product is discharged from the production chamber, a heating arrangement configured to heat product which is in the production chamber to a predetermined temperature, wherein the structure is mounted to a frame with a vibratory mechanism between the frame and the structure which is configured and which is operative to impart controlled vibratory movement to the production chamber and to the product in the production chamber, and wherein the vibratory mechanism includes rubber vibratory suspension elements between the frame and the structure.

38. A furnace according to claim 37, wherein the heating arrangement is at a location which is below the production chamber.

39. A furnace according to claim 37, wherein the inlet port is at a first end of the production chamber and the discharge port is at a second end of the production chamber which is remote from the first end.

40. A furnace according to claim 37, wherein the structure includes an outlet from the production chamber through which combustible gas, produced upon heating and hence the reduction of the product in the production chamber, is directed.

41. A furnace according to claim 37, wherein through the vibratory movement the particles in the production chamber are interstitially spaced from one another.

42. A furnace according to claim 37, wherein the production chamber is located in an upper housing and the heating arrangement is located in a lower housing positioned below the upper housing with a refractory medium between the housings.
